(19) United States
(12) Patent Application Publication
(10) Pub. No.: US 2011/0094356 A1
(43) Pub. Date: Apr. 28, 2011

(54) Quick-Change Threading Tool Holder

(76) Inventor: Robert Dunn Howerton, Decatur, GA (US)

(21) Appl. No.: 12/761,706

(22) Filed: Apr. 16, 2010

Related U.S. Application Data
(60) Provisional application No. 61/169,958, filed on Apr. 16, 2009.

(51) Int. Cl. B23B 29/12

(52) U.S. Cl. 82/160

(57) ABSTRACT

A quick-change tool holder designed to facilitate thread cutting on manual metal cutting lathes. The tool holder mounts on a face of a prior art quick-change tool post that is mounted on the lathe compound rest with a face parallel to the axis of the compound rest and a face perpendicular to this axis and holds the axis of the cutting tool at a particular horizontal angle with respect to the face of the tool post so that, when the compound rest is rotated so as to feed the cutting tool in a preferred direction, the tool axis becomes either perpendicular or parallel to the axis of the work piece to be threaded in the cases of external or internal threading respectively. The threading tool holder also has an external vertical face parallel to the axis of the cutting tool that facilitates setting the angle of the compound rest.

### CROSS REFERENCE TO RELATED APPLICATIONS

This application claims the benefit of the U.S. Provisional Patent Application entitled “QUICK-CHANGE THREADING TOOL HOLDER”, Ser. No. 61/169,958, filed Apr. 16, 2009, which is incorporated by reference.

### BACKGROUND OF THE INVENTION

Producing a part on a manual metal working lathe usually involves a sequence of operations such as rough turning and facing followed by finish turning and facing, perhaps boring, and then possibly cutting off the piece, reversing it in the lathe chuck and finish facing the cut-off end to complete the machining of the part. Each of these operations generally requires a different type of cutting tool or a different orientation of the cutting tool and, in the 1950's when most lathes were equipped with a rocker tool post which accommodated a tool holder with an installed tool bit, removing one tool holder and installing and aligning another tool holder required a considerable amount of time and attention and significantly increased the cost of producing the part.

F. Sirola patented in July 1946 (U.S. Pat. No. 2,403,405) what today would be called a quick-change tool post that accommodated a plurality of quick-change tool holders. It was not until the mid 1960's that these devices became commercially available and it was not until the mid 1970's that their price became low enough for the small machine shop to find them cost effective. By this time, however, the quick-change tool post and its associated quick-change tool holder had evolved into a highly practical innovation in metal working technology that significantly reduced the cost of parts produced on a manual lathe: roughing and finishing tool bits can be mounted in tool holders, some oriented for turning and others for facing; cut-off tools and boring bars can be mounted in other tool holders and there are specialized tool holders for processes such a knurling. There is a provision in each tool holder for precisely adjusting the height of the tool bit. By turning a lever, usually at the top of the tool post, any tool holder can be unlocked and removed and another tool holder can then be mounted and locked with precisely the correct height and orientation. Removing and replacing tool holders can be accomplished in seconds and the operator is assured of its proper alignment.

### BRIEF SUMMARY OF THE INVENTION

But, at present, there remains the very common lathe operation of threading, where it is necessary to loosen the quick-change tool post from its fixed mounting and precisely align and tighten it in a different orientation. And, upon completion of the threading operation, it is again necessary to loosen the tool post and precisely align and tighten it in its original orientation. Both of these are onerous and time-consuming operations. The present invention is a modified quick-change tool holder that obviates both operations.

In the years since its original invention, the quick-change tool post and its associated tool holder have evolved into essentially three different forms: i.) the fixed tool post with two perpendicular faces that can mate with removable tool holders; ii.) the rotatable tool post with up to four orthogonal faces that can mate with removable tool holders and iii.) a rotatable tool post that incorporates four integrated orthogonal tool holders. (This last form is often referred to as a turret tool post.) The differences between these forms will be discussed in more detail below. The present invention is primarily intended to be used with (a modification of) the quick-change tool post of the first form, which is significantly less expensive and more practical than the other two forms. It will be explained below, however, that the invention can overcome certain significant shortcomings of the other two types in the threading operation. (Please note that the modification of the first type of quick-change tool post will be covered by a sister patent to that of the present invention.)

### BRIEF DESCRIPTION OF THE DRAWINGS

With reference to the foregoing, the following specifications and the accompanying drawings, in which the preferred embodiment of the invention is incorporated, are now presented. In the drawings,

FIG. 1 is a drawing of the modified quick-change tool post;

FIG. 2 is a drawing of the existing quick-change tool holder;

FIG. 3 is a drawing of the modified quick-change threading tool holder, the subject of this patent. All of these figures show their objects in perspective views. There follow three drawings,

FIGS. 4, 5 & 6, which show these parts as they are mounted on the lathe for the operations of turning, external threading and internal threading, respectively. These figures also show the assemblies in perspective views.

FIG. 7 is a drawing of a quick-change threading bar holder that is also the subject of this patent.

FIG. 8 shows what might be called a poor man's version of the present invention.

FIG. 9 is a schematic drawing showing the preferred manner of feeding the tool bit in the threading operation.

FIG. 10 is a similar schematic drawing showing the results of an unacceptable manner of feeding the tool bit.

FIG. 11 is a schematic drawing of the compound rest, the tool post and the tool holder that illustrates certain important geometrical relations between these objects.

### DETAILED DESCRIPTION OF THE INVENTION

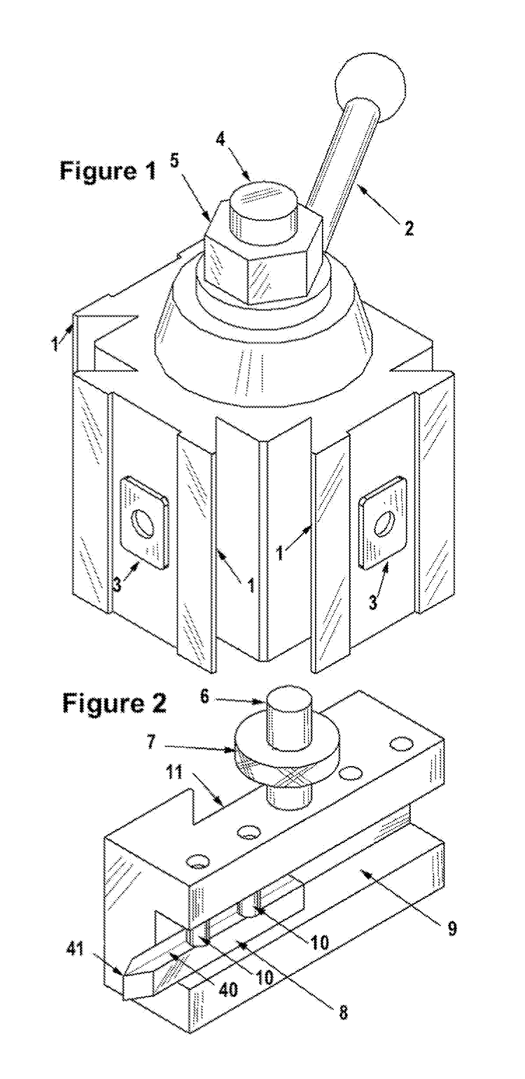

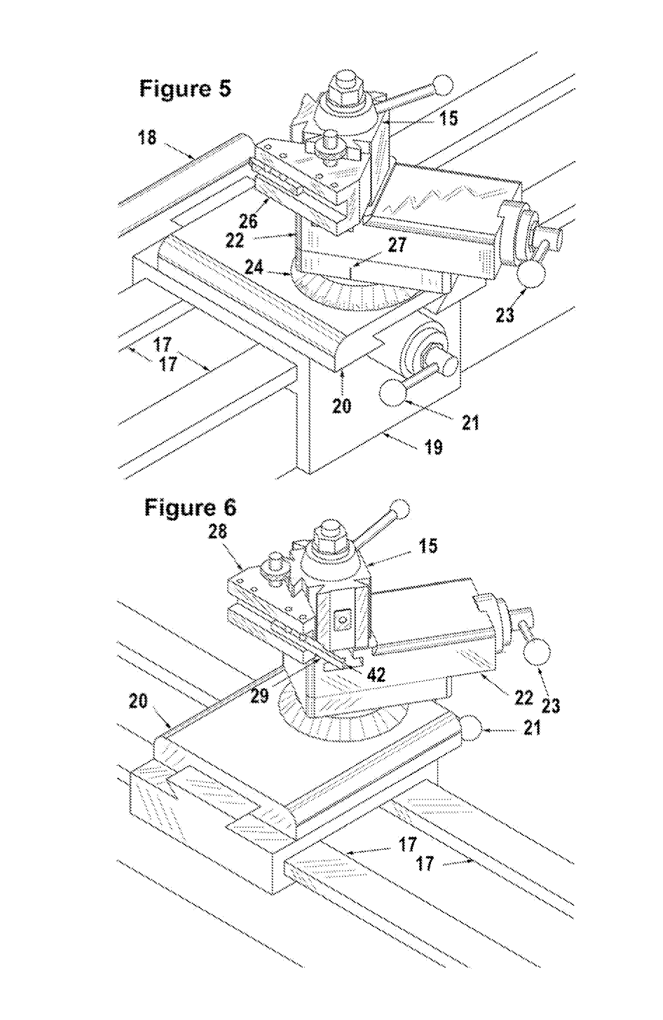

Referring to FIG. 1, it is noted that the modified quick-change tool post has three faces that incorporate dovetail tongues 1 on which a quick-change tool holder may be mounted rather than the two faces of the conventional tool post of the first form. The face on the right in the figure is designated the left face; the face on left is designated the front face and the face behind is designated the right face. Each of these faces has a rectangular piston 3 which is forced out against a mounted quick-change tool holder by an internal cam that is articulated by rotating the tool post-locking lever 2 clockwise to lock the tool holder in place. The tool post is mounted rigidly on the lathe compound rest by a T-Nut that is engaged by the tool post mounting bolt 4 and the tool post-mounting nut 5. (The compound rest will be shown in FIGS. 4, 5 & 6.)

FIG. 2 shows the tool holder dovetail retaining recess 11 that mates with the dovetail tongue 1 of the tool post; the clearances between the tongue and the recess are such that the tool holder can slide up and down easily on the tool post until the locking piston is engaged. Projecting from the top of the tool holder is the threaded height bolt 6 on which is mounted the knurled, threaded height adjustment disk 7 which is allowed to rest on the top of the tool post to set the height of the top of the tool bit 8 before the piston is engaged. (In the actual part there are simple locking arrangements for the adjustment disk to keep it from rotating inadvertently.) The tool bit 8 is mounted against the wall of the tool bit channel 9 that is precisely parallel to the opposite face of the tool holder; here the tool bit extends from the left end of the tool bit channel (i.e. the ends of the channel are dubbed left or right as seen from the side opposite the dovetail recess); the tool bit is held rigidly in place by the Allen-head set screws 10. (Note that some tool holders have a small v-notch running midway in the base of the channel from end to end in order to accommodate small boring bars or cylindrical threading tools.) The tool bit axis 40 is shown as parallel to the shank of the bit; the cutting tip of the tool bit 41 is also shown. These last items will be discussed later.

It is well to note that the faces of the quick-change tool post and the mating face of the quick-change tool holder incorporate relatively large flat vertical surfaces, namely the exterior faces of the dovetail tongues and the interior face of the dovetail recess of the tool post and the tool holder, respectively. And this observation (as well as the observation that the metal cutting tool axis is horizontal) applies to all of the commercially available quick-change tool systems as well as to quick-change tool systems covered in the patent literature. It is thus both reasonable and rigorous to specify the orientation of the metal cutting tool axis as bearing a certain horizontal angle with respect to a face of the tool post or to the face of a tool holder. Furthermore, it is noted that the dovetail tongues and recesses are symmetrical about a vertical plane perpendicular to their faces and located at their centerlines. This symmetry also happens to pertain to the single quick-change tool system, of the forms i) & ii) noted above, that does not employ interlocking dovetail mounting faces, to with, that patented by C. Gracchi in March 1950 (U.S. Pat. No. 2,621,396). This last observation pertains to tool holders that can be profitably “turned upside down” as will be mentioned below.

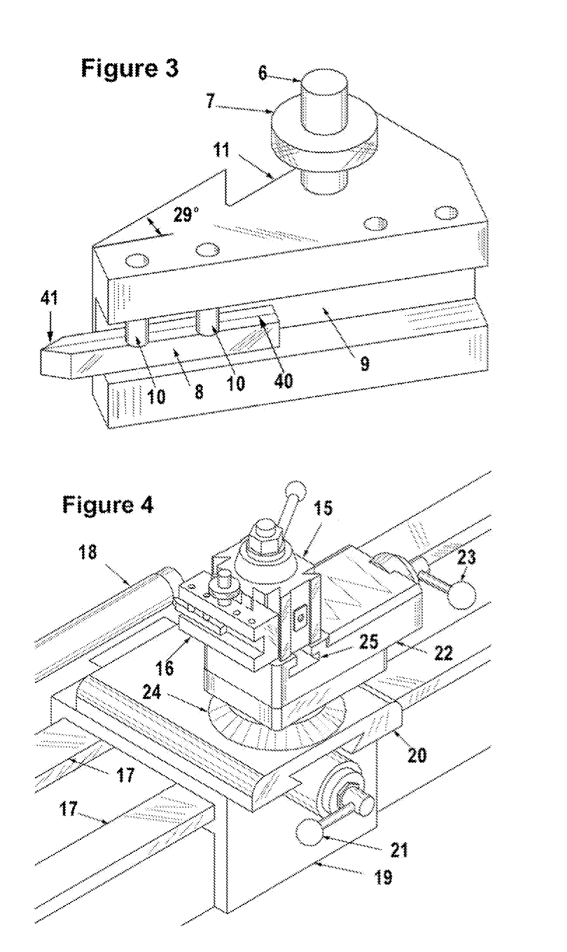

FIG. 3 shows the threading tool holder that is the subject of this patent. It is identical to the standard tool holder in every respect but two: it includes the dovetail retaining recess 11, the height bolt 6 and the height adjustment disk 7, the tool bit channel 9 and the Allen-head set screws 10. The two differences are the following: i.) the axis of the tool bit channel 9 is canted at a horizontal angle of 29° to the face of the dovetail recess 11 and ii.) there is a threaded hole in the bottom of the threading tool holder whose axis coincides with the axis of the threaded height bolt 6, since the threading tool holder is sometimes used in the orientation shown, but in others flipped 180° about the axis of the tool bit channel 9. (These two orientations are shown in FIGS. 5 & 6.) The tool bit axis 40 and the tool cutting tip 41 are also shown in this figure.

In the specification of the invention here, the horizontal angle through which the axis of the tool bit is rotated with respect to the face of the dovetail recess will be taken as positive when the rotation is counter-clockwise when seen from above. Thus the angle of rotation as shown in FIG. 3 is negative. Conversely, the angle of rotation when the tool holder is flipped is positive. This same convention will be used below in the case of horizontal rotations of the compound rest.

FIG. 4 shows the (modified) quick-change tool post and the standard quick-change tool holder as mounted on the lathe for turning operations. In this drawing the lathe carriage 19 can move on the stationary lathe bed ways 17 toward the left or the right under the control of the longitudinal power feed mechanism that includes a gear train, lead screw and a half-nut that is attached to the carriage (none of which are shown). The top of the carriage includes the cross feed 20, which moves the tool bit perpendicularly either toward or away from the rotating (chuck mounted) work piece 18 by means of the lead screw (not shown) attached to the cross feed advance knob 21. The horizontal axis that runs through the center of the work piece is designated the axis of the lathe.

The compound rest 22 is attached to the top of the cross feed by an arrangement that allows it to be rotated horizontally full-circle about a vertical axis fixed in the cross feed: a vertical cylindrical hub is located at the center of the conical section 24; the low end of the hub devolves into a short inverted conical section that mates with two bevel-ended dowel pins in the body of the compound rest that are forced against the hub by set screws to lock the compound rest down and in a particular angular position (none of this is shown). The conical section 24 is graduated about its perimeter in degrees and a mark 27 on the bottom of the compound rest adjacent to the degree scale indicates the angular position of the compound rest. (The angular position shown in this figure is designated positive 90° and is the default position of the compound rest; when the axis of the compound rest is perpendicular to the axis of the lathe, its angle is 0° and this position will be designated its home position. Note that, by the conventions adopted here, if it is rotated a certain angle from this home position in the counter-clockwise sense, its angle is deemed positive; conversely, if it is moved in the clockwise sense its angle is deemed negative.) The compound rest includes a feed mechanism that, in this angular position, moves tool bit parallel to the axis of the work piece either left or right by means of a lead screw (not shown) attached to the lead screw knob 23. The precise direction in which the tool bit moves when the compound rest lead screw is turned is denoted the axis of the compound rest. Note that the power feed mechanism of the lathe carriage can be disengaged, the carriage can be locked in place and the manual feed mechanism of the compound rest can be used to machine short cylindrical segments of the work piece.

Also note that the quick-change tool holder can be removed from the tool post face shown in this figure and placed on the face to the right and a second tool bit placed in the other end of the tool bit channel is thus positioned for facing; here a latitudinal power feed can be engaged for successive facing cuts whose depths are determined by the compound rest manual feed.

The position of the quick-change tool post with respect to the compound rest, as shown in FIG. 4, will be designated its default position. Note that the left and right faces of the tool post are parallel to the axis of the compound rest and that the front face is perpendicular to this axis. Also note that when both the compound rest and the tool post are in their default positions and a tool holder is mounted on the front face of the tool holder, the tool bit mounted in the holder, as shown in FIG. 4, is oriented for turning; and when the tool holder is mounted on the right face of the tool holder with a tool bit mounted in the other end, the tool bit is oriented for facing.

At this point it is convenient to consider a difficulty in the use of a manual metal cutting lathe: since the manual feed of the compound rest is used to machine short cylindrical segments, it is necessary that the axis of the compound rest be precisely parallel to the axis of the work piece (i.e. the longitudinal axis of the lathe), but the 1° graduations of the angular scale are quite small and hard to read; furthermore, it is not uncommon for there to be errors of up to a degree in the positioning of the scale. For this reason the following complicated procedure is required to set the compound rest in its default 90° position: a precision ground round piece of at least ¾ inch diameter must be mounted in a 4-jaw chuck and precisely centered with a dial indicator (of 0.0005 inch or less graduations) and checked for parallelism with the dial indicator over a movement of at least 2 inches of the lathe carnage. The dial indicator is then mounted on the compound rest and, with the carriage locked, the deviation noted on the dial indicator over the approximately 1.5 inch of the compound rest feed range. The angular position of the compound rest should then be adjusted so that (ideally) there is no visible deviation of the dial indicator. This is indeed an onerous procedure.

With the advent of the quick-change tool post and the quick-change tool holder a much simpler procedure became available: without the tool post mounted on the compound rest, the above procedure is performed once and the precision round is left in the 4-jaw chuck; then the quick-change tool post is loosely mounted on the compound rest and a quick-change tool holder of the type shown in FIG. 2 is mounted on the tool post face (to the right of the face on which the tool holder is mounted in FIG. 4) and locked into position; then the cross feed is used to position the (tool bit channel) face of the tool holder comfortably up against the precision round; while holding the tool post/tool holder assembly tightly against the round, the tool post mounting nut 5 is tightened. The precise alignment of the face of the tool holder with the precision round is then checked with ½ mil shim stock at either end of the face and the mounting nut is then forcibly and securely tightened with the intention of never removing the tool post from the compound rest. (It should be pointed out that it is only feasible to carry out this intention by making use of the threading tool holders that are the subject of the present patent.)

With this operation completed, whenever the compound rest is moved from its default position it can be returned to this position by loosening its two set screws, by installing the tool holder on either the front face or the right face of the tool post and then by moving the compound rest up against a (reliable) face plate mounted on the lathe spindle by moving the lathe carriage or by moving it up against a precision round mounted in a (reliable) 3-jaw chuck by moving the cross feed and then by tightening the set screws to lock the compound rest in place. With practice, this procedure can be executed in seconds. The foregoing issue is of importance here because standard lathe practice calls for setting the compound rest at an angle other than its default position for cutting threads.

A brief description of thread cutting on a lathe is now presented. Screw thread forms can vary widely from square threads to Acme threads to so-called buttress threads, but the focus here will be on the American National Screw Thread Form that is almost universally used for fasteners and machine parts. Here the sides (or faces) of the thread form an angle of 60° with each other; the tops of the threads are slightly truncated, as are the valleys between the threads. (Detailed specifications over the range of threads is given in the reference [c] of the Technical Literature cited.)

Cutting threads is generally a multi-pass operation. There are two feeding operations: first, while outside the right-hand range of the thread with the lathe stopped, the threading tool bit is fed toward the axis of the round work piece by the compound rest feed, as explained below, and then the longitudinal power feed is engaged and the lathe is started, so that, with the work piece rotating, the carriage travels to the left at a rate that is determined by the pitch of the thread, i.e. if the pitch is 10 threads per inch, the carnage advances 1/10 inch for every revolution of the work piece. On arrival at the left-hand limit of the thread the lathe is stopped and this completes the first thread-cutting pass. Then the cutting tool is disengaged from the work piece by means of the cross feed; the carnage is moved manually to a point beyond the right-hand range of the thread; the cutting tool is returned to its last position by means of the cross feed and then fed a small amount further by the compound rest in order to begin the next thread-cutting pass.

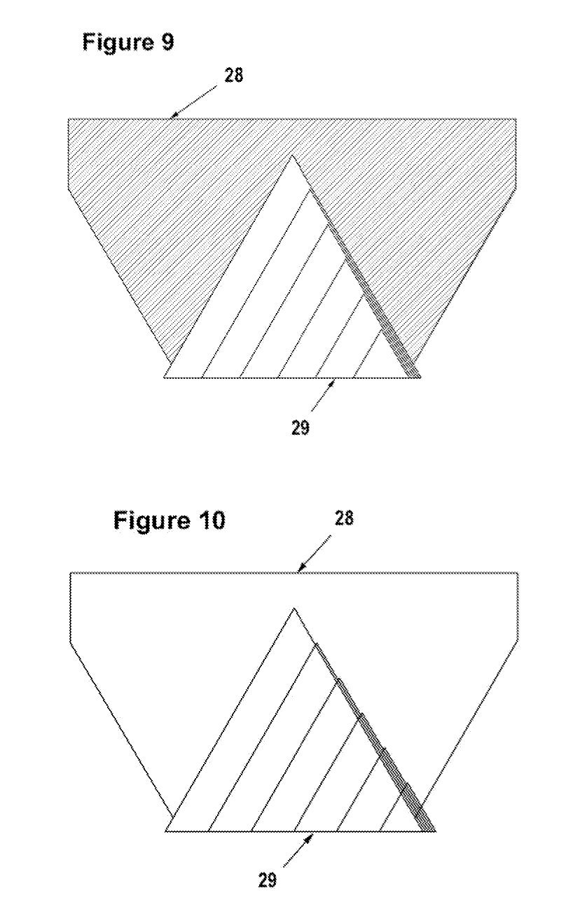

A threading tool bit, meticulously designed for cutting unified threads, will have a symmetrical truncated triangular tip with an included angle of 60° with chip clearances for a range of thread pitches; the tool bit must be held perpendicular to the axis of the round to be threaded. And accepted lathe practice calls for the tool bit to be fed into the thread with the compound rest set at an angle of 29° counter-clockwise from the direction that is perpendicular to the axis of the lathe in the case of right-hand external threads. In conformity with the convention established above, this angle is deemed positive. (This is rotated clockwise 61° from its default position of 90°.) FIG. 9 shows schematically the trajectory of the tool bit as it is fed into the thread: a cross section of the threaded piece 29 is shown and successive tool bit positions 28 are shown. It is seen that on each pass the majority of the metal removed is on the left face of the thread; there is only a light chasing cut on the right face of the thread. (Actually, FIG. 9 shows feeds with the compound rest set at 27° off the perpendicular, else the chasing cuts would not be visible.) FIG. 10 shows schematically the unacceptable tool trajectory when the feed angle is greater than the 30° thread face angle of the American National Screw Thread Form: here the right face of the thread exhibits a number of small steps and the average angle of the face becomes the tool feed angle which will not conform to the left-hand face of the correct mating internal thread. This observation suggests that even the 30° feed angle that is attainable with rotating quick-change tool posts, as discussed below, may not be an acceptable tool feed angle.

A theoretical justification of this feeding practice might be the following: cutting threads on a lathe entails extremely large cutting forces and tool chatter is sometimes observed with consequent roughness on the left-hand face; but the right hand face, subject as it is with only a light chasing cut, can remain smooth and it is the right face of an external thread that bears the force of a tightened nut. Another justification is that putting most of the cutting action on the left-hand face minimizes the play in the gear train and the lead screw of the power feed mechanism.

This feeding practice may have evolved from experience with no theoretical justification, but it seems to be universally prescribed in shop practice manuals: in the large library of a well-known technical institute the practice is called for in all of the manuals published from 1977 to 1984, which are the latest in the collection. But the practice is not universally accepted: a tool manufacturer represented in the large machine tool catalogs specifies that its internal carbide threading tool be fed in a perpendicular direction. The treatise on metal cutting technology [a] cited in the academic references indicates another manufacturer of carbide threading tools allows feeding in the 29° direction, in an alternating +/−29° zigzag manner and in the perpendicular direction. But the two clinchers are included in the technical paper [b] cited in the academic references: first the author relates that the Computer Numerically Controlled (CNC) lathe used in the study had built-in computer software that fed the threading tool in the 29° direction, in the perpendicular direction or in the +/−29° zigzag manner and then the author stated that the 29° feed led to the best results. He also said that some tool chatter was observed in the tests. It is worth pointing out here that the present invention is not needed on CNC lathes since the computer program moves the tool bit arbitrarily.

So finally FIG. 5 shows the lathe set up for external threading with the quick-change threading tool holder 26 mounted on the left-hand face of the (modified) quick-change tool post, which has not been moved from its permanently fixed, default position on the compound rest. Note that angular position of the compound rest does not have to be set at the required 29° off the perpendicular by reading the close and possibly inaccurate angle scale: if a (reliable) faceplate can be conveniently mounted on the lathe spindle, the carriage can be moved so that the (tool channel) edge of the threading tool holder butts up against the face plate and the compound rest setscrews can then be tightened. This assures that the threading tool bit is exactly perpendicular to the axis of the lathe and that the compound rest is exactly 29° off the perpendicular. If mounting the faceplate is inconvenient, the threading tool holder can be temporarily mounted on the front face of the tool post and the cross feed can be used to butt the face of the tool holder against the work piece and the setscrews tightened as above. With these quick and easy steps, the lathe is set up for external (right-hand) threading.

FIG. 6 shows the lathe set up for internal (right-hand) threading. In this case the compound rest should be set at an angle of 29° clockwise from the perpendicular, which according to the convention established above is a negative angle. In this figure the threading tool holder 28 is the same tool holder 26 in the previous figure but it is upside down and the height bolt has been moved from one side to the other. Note that the tool bit 42 used for internal threading has a cutting tip that is perpendicular to the axis of the tool shank.

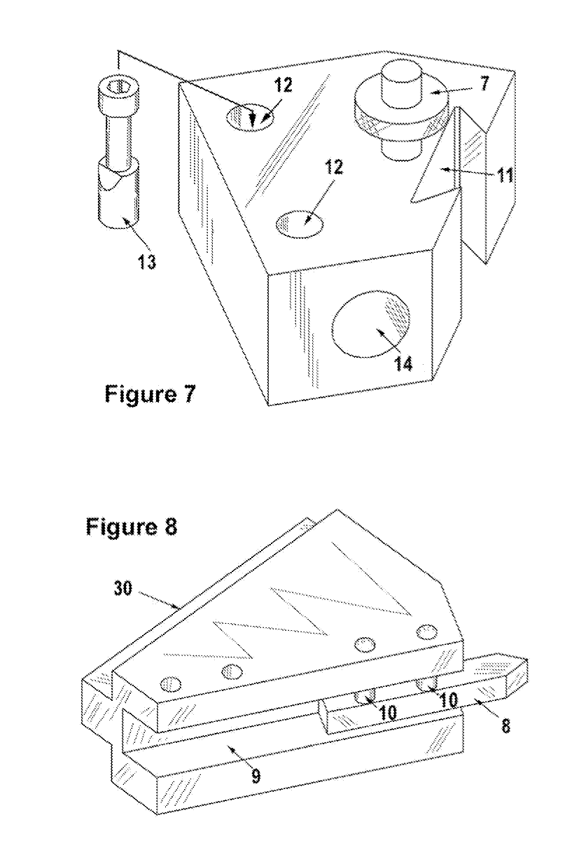

FIG. 7 shows a threading bar holder. It includes the dovetail retaining recess 11 that mates with the tool post dovetail tongue and the height-adjusting disk 7 of previous tool holders and also the cylindrical bar receptacle 14 with bar retaining nut receptacles 12 and bar retaining nuts 13. The threading bar holder is typically used for deeper internal threads in the same manner as the upside-down threading holder of FIG. 6. Note that the axis of the bar has been rotated clockwise from the face of the dovetail so that the angle is taken to be positive. When left-handed threads are cut, the compound rest angles are reversed: clockwise for external threads and counter-clockwise for internal threads.

FIG. 8 shows an alternative, possibly cheaper to manufacture, form of the threading tool holder. Here, in place of the dovetail recess, the tool holder has a rectilinear tongue 30 that fits into the tool bit channel of the standard quick-change tool holder. The horizontal angle between the face of the tongue and the face of the tool bit channel 9 is 29° just as in the previous threading tool holders. (In the claims, instead of the face of the tongue the term axis of the tongue is used. This axis will be taken to coincide with an exterior longitudinal edge of the rectilinear tongue.) The height bolt and the height-adjusting disk are not needed on this form since these items are on the standard tool holder into which this form is inserted. Also note that the threading tool holder shown here is configured for left-hand external threading.

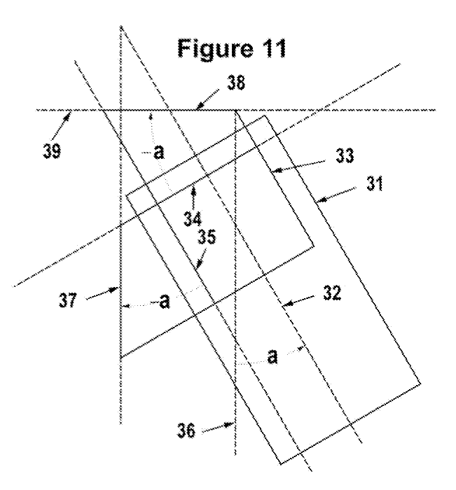

At this point it is well to consider the two principal aims of the novel quick-change threading tool holder and to demonstrate that the novel tool holder achieves these aims by means of geometric principles: the first aim is to insure that the axis of the threading tool is perpendicular to the work piece when the compound rest is rotated through a recommended angle from the perpendicular without having to rotate the tool post which should remain fixed on the compound rest; the second aim is to afford a face on the tool holder that can be used to accurately position the compound rest by butting this face up against a face plate or by mounting the tool holder on an orthogonal tool post face and butting the tool holder face up against the round work piece. FIG. 11 is a schematic drawing that permits this demonstration: the compound rest is represented by the rectangle 31 and its axis 32; the tool post is represented by the square 33 and it is assumed that the tool post has at least one face 35 parallel to the axis of the compound rest and at least one face 34 perpendicular to this axis. In the figure, the compound rest is shown rotated through the angle a from the axis 36 that is perpendicular to the longitudinal axis 39 of the lathe (where the angle is counter-clockwise and thus positive). Since the face 35 is parallel to the axis 32 of the compound rest and since the face 37 of the tool holder (represented by the trapezoid adjacent to the tool post) is rotated by the negative of the angle a then, by the principles of plane geometry, this face is perpendicular to the lathe axis and thus the compound rest angle can be set by butting this face up against a face plate. And since the axis of the tool bit is parallel to the face of the tool holder, the bit is perpendicular to the work piece. If it is not convenient to mount a faceplate to set the compound rest, note that the tool holder can be quickly mounted on the orthogonal tool post face so that the holder face becomes parallel to the lathe axis and this face can be butted up against the work piece to set the compound rest. This takes care of external threading, no matter what the thread type is.

As noted above, internal threading is performed with a cutting tool where the cutting tip is at a right angle to the axis of the cutting tool; this axis should therefore be parallel to the lathe axis. Internal threading also requires that the feed angle be the opposite of that used with external threading and thus the compound rest should be rotated clockwise and its angle becomes −a and the required tool holder angle a is easily achieved by turning the same tool holder that was used for the external threading upside down and then mounting it on the tool post face that is perpendicular to the axis of the compound rest.

Finally, before stating the claims, a number of matters are discussed: there are at least five manufacturers of quick-change tool posts and tool holders and each manufacturer can have four or more sizes. There is some interchangeability between the posts and the holders of the various manufacturers, but this is not guaranteed. Most of the dovetails on the holders have the 45° angle that is shown in the drawings in this patent application, but some dovetails may have other angles. Furthermore there are at least two types of locking mechanisms: piston and wedge. It will be claimed below that this patent covers all tool holder sizes without regard to the angle of the dovetail or, for that matter, without regard to the details of the interface between the post and the holder including the locking mechanism.

It was noted above that there are three different forms of quick-change tool posts and that the invention covered by this patent application is primarily intended for the first form, which is fixed on the compound rest. The second form can be rotated through an arbitrary but fixed number of positions (which always includes 0°, 90°, 180° and 270°). It may be that some tool posts rotate clock-wise and counter-clockwise by an angle of 30°, which would be an acceptable threading angle, but it is very unlikely that rotation of 29° would be achievable, which is the recommended angle. So the invention presented here allows the recommended angle on these tool posts. It is also quite unlikely that a rotation of 14.5°, which is recommended for cutting Acme threads, would be achievable or anything close to this angle. So the present invention is needed to cut Acme threads if the tool post is not to be removed from the compound rest. Similar comments apply to buttress thread.

The third form of quick-change tool post is often called a turret tool post and one, in particular, has 12 positions which would include the 30° rotation noted as acceptable above. But the tools that can be mounted on these turret posts include a dovetail tongue on which the threading tool holder presented here can be mounted; thus the recommended angle of 29° can be achieved. And, clearly Acme threading tool holders can also be mounted on the turret tool holder.

The quick-change threading tool holders that are the subject of this patent application can be used with an un-modified quick-change tool post of the first form, i.e. a tool post with only two mounting faces. In the case of external threads the tool holder is mounted on the right-hand face of the tool post so that the threading tool bit is perpendicular to the work piece with the compound rest rotated 29° counter-clockwise. With this arrangement the tool post itself is to the left of the tool bit tip and its width of roughly 3 inches may interfere with the chuck that is holding the work piece if threading within 3 inches of the chuck is desired.

There is an existing, commercially available, product called a swivel cartridge tool holder that incorporates a carbide insert swivel head or a high-speed steel swivel head, both of which can be rotated horizontally left or right by 15° increments from the axis of the tool shank. The manufacturer recommends the device for left- or right-hand turning, boring, facing or chamfering, but makes no mention of its use for threading when, in fact, it can be used for external threading with the compound rest rotated 30° off the perpendicular and with the device mounted in the standard quick-change tool holder which is, in turn, mounted on the (modified or standard)) quick-change tool post without moving the tool post from its fixed position. So this existing device accomplishes, in a different way, one of the principal aims of the present invention but only in the case of standard, unified external threads, and this only approximately. It cannot handle Acme or buttress threads and, perhaps more importantly, it does not enable the lathe operator to set the compound rest angle precisely without reference to the possibly inaccurate angle scale, which is another principal aim of the present invention. And (since the head cannot swivel more than 90°) the device cannot cut standard internal unified threads with any rotation of the compound rest, or any internal thread, for that matter.

A final comment: the particular shapes of the quick-change threading tool holders shown in the drawings in this patent application are reasonable and probably feasible, but the only crucial feature of the shapes is the horizontal angle between the axis of the tool bit channel or the boring bar receptacle and the mounting face, which shall be 29° in the case of unified threads (or other particular angle that is recommended on the basis of experience or of theoretical considerations to best perform the threading operation). Other aspects of the shapes will be determined by mechanical design considerations such as increasing rigidity or minimizing manufacturing costs.

1. A quick-change threading tool holder that attaches to any one of a plurality of mounting faces of a quick-change tool post and that rigidly supports a metal cutting tool where the axis of said metal cutting tool is horizontal and bears a certain precise, predetermined horizontal angle, other than zero, to the mounting face to which it attaches.

2. The quick-change threading tool holder of claim 1 where said tool holder possesses an external flat vertical face that is precisely parallel to said axis of said metal cutting tool.

3. The quick-change threading tool holder of claim 2 where said tool holder possesses a threaded vertical hole running from the bottom to the top of said tool holder, close to the edge of said tool holder that mates with said tool post, into which a height bolt can be threaded and onto which a height disk may, in turn, be threaded and where said height disk may rest on the top of said tool post to adjust the height of said tool holder.

4. The quick-change threading tool holder of claim 3 comprising
a dovetail recess that mates with a dovetail tongue incorporated in each of a plurality of faces of a quick-change tool post where said tool post is, in turn, securely mounted on the compound rest of a manual metal cutting lathe with at least one face parallel to the axis of said compound rest and at least one face perpendicular to said axis of said compound rest and where said tool post includes a locking mechanism that facilitates the quick, repeatedly accurate positioning and rigid mounting of said dovetail recess on said dovetail tongue of said tool post and also facilitates the quick, repeatedly accurate positioning and rigid replacement of said tool holder with a different subsequent quick-change tool holder,
an exterior flat vertical face that is opposite the dovetail recess and where said exterior flat vertical face bears a precise, predetermined horizontal angle, other than zero, to the internal face of said dovetail recess,
a horizontal rectangular channel running from one side to the other of said tool holder, whose outer edge coincides with said exterior flat vertical face and whose upper and lower facets have a plurality of threaded, centered vertical holes that can accommodate Allen-head set screws to rigidly retain a rectangular cutting tool in said horizontal rectangular channel where, by virtue of the orientation of said horizontal rectangular channel with respect to said exterior flat vertical face, the axis of said cutting tool bears said precise, predetermined horizontal angle to said internal face of said dovetail recess,
a vertical threaded hole that runs from the top to the bottom of said tool holder and is close to the edge of said dovetail recess and into which a height bolt may be threaded that, in turn, has threaded on it a height disk that rests on the top of said quick-change tool post to set the height of said quick-change threading tool holder before said locking mechanism of said quick-change tool post is engaged,
whereby
when said quick-change tool post possesses dovetail tongues on three faces, where the left and the right faces are parallel to said axis of said compound rest and where the front face is perpendicular to said axis and where said compound rest is in its default position,
then with said threading tool holder mounted on the right face of said tool post, with a rectangular external threading tool mounted with its tip extending from the left end of said rectangular channel, the axis of said threading tool becomes perpendicular to the longitudinal axis of said lathe when said compound rest is rotated through an angle whose magnitude equals said precise, predetermined horizontal angle above but whose sense is opposite to said angle above and where said opposite angle may be set by loosening the set screws that fix said compound rest and butting said exterior flat face of said tool holder up against a face plate mounted on the spindle of said lathe and then tightening said set screws without reference to the angle scale of said compound rest or, preferably,
said opposite angle may be set by temporarily mounting said tool holder on said front face of said tool post and butting said exterior face of said tool holder up against the chuck mounted work piece, tightening said set screws and then restoring said tool holder to said right face, at which point said lathe is configured for external threading where said precise, predetermined angle is the recommended tool feed angle for the thread form in question, or
with said tool holder mounted upside down on the front face of said tool post, which reverses the sense of the above precise, predetermined angle, with a rectangular internal threading tool mounted with its tip, which is perpendicular to the axis of said tool, extending from the right side of the inverted tool holder, the axis of said threading tool becomes parallel to said longitudinal axis of said lathe when said compound rest is rotated through an angle whose magnitude equals that of said reversed angle but whose sense is opposite to said reversed angle and where said opposite angle may be set by loosening the set screws of said compound rest and butting said exterior face of said inverted tool holder up against said chuck-mounted work piece and then tightening said set screws without reference to said angle scale of said compound rest, at which point said lathe is configured for internal threading where said reversed precise, predetermined angle is the recommended tool feed angle for the thread form in question,
where it is noteworthy that the set-up of neither of the above turning configurations requires the re-orientation of said tool post with respect to said compound rest on which it is mounted.

5. The quick-change threading tool holder of claim 4 wherein said certain precise, predetermined horizontal angle is
in the range from some small angle to 30°, but preferably 29°, in the clockwise sense for cutting right-hand external thread in the case of American National Screw Thread Form and
in the range from some small angle to 14.5°, but preferably 14.5°, in the clockwise sense for cutting right-hand external threads in the case of the Acme thread form and
similarly determined feeding angles for other thread forms.

6. The quick-change threading tool holder of claim 4 wherein said horizontal rectangular channel includes a small centered v-notch running midway from end to end in the upper and lower facets of said channel whereby a small boring bar or cylindrical threading tool may be mounted in said tool holder.

7. The quick-change threading tool holder of claim 6 wherein said certain precise, predetermined horizontal angle is
in the range from some small angle to 30°, but preferably 29°, in the clockwise sense for cutting right-hand external thread in the case of American National Screw Thread Form and
in the range from some small angle to 14.5°, but preferably 14.5°, in the clockwise sense for cutting right-hand external threads in the case of the Acme thread form and
similarly determined feeding angles for other thread forms.

8. The quick-change threading tool holder of claim 4 wherein said rectangular tool channel and said plurality of centered threaded holes are replaced by a larger internal horizontal cylindrical channel whose axis bears a precise, predetermined horizontal angle, other than zero, to said internal face of said dovetail recess and that runs from one side to the other of said tool holder in order to accommodate a boring bar and including
a plurality of vertical retaining nut and bolt receptacles that intersect said horizontal cylindrical channel, and
a corresponding plurality of retaining nuts and bolts that grip said boring bar, and
an external flat vertical face that is parallel to the axis of said cylindrical channel.

9. The quick-change threading tool holder of claim 8 wherein said certain precise, predetermined horizontal angle is
in the range from some small angle to 30°, but preferably 29°, in the clockwise sense for cutting right-hand external thread in the case of American National Screw Thread Form, and
in the range from some small angle to 14.5°, but preferably 14.5°, in the clockwise sense for cutting right-hand external threads in the case of the Acme thread form, and
similarly determined feeding angles for other thread forms.

10. A threading tool holder that possesses a rectangular tongue that can be rigidly gripped by the tool channel of a standard, prior art quick-change tool holder and that rigidly supports a metal cutting tool where the axis of said tool is horizontal and bears a certain precise, predetermined horizontal angle, other than zero, to the axis of said rectangular tongue.

11. The threading tool holder of claim 10 where said tool holder possesses an external flat vertical face that is precisely parallel to said axis of said metal cutting tool and thus bears said horizontal angle to said axis of said rectangular tongue.

12. The threading tool holder of claim 11 that includes a horizontal rectangular channel running from one side to the other of said tool holder whose outer edge coincides with said exterior flat vertical face and whose upper and lower facets have a plurality of threaded, centered vertical holes that can accommodate Allen-head set screws to rigidly retain a rectangular metal cutting tool in said rectangular channel.

13. The quick-change threading tool holder of claim 12 wherein said certain precise, predetermined horizontal angle is
in the range from some small angle to 30°, but preferably 29°, in the clockwise sense for cutting right-hand external thread in the case of American National Screw Thread Form, and
in the range from some small angle to 14.5°, but preferably 14.5°, in the clockwise sense for cutting right-hand external threads in the case of the Acme thread form, and
similarly determined feeding angles for other thread forms.

14. The threading tool of claim 12 where said rectangular channel includes small centered v-notches running midway from end to end in the upper and lower facets of said channel whereby a small boring bar or cylindrical threading tool may be mounted in said tool holder.

15. The quick-change threading tool holder of claim 14 wherein said certain precise, predetermined horizontal angle is
in the range from some small angle to 30°, but preferably 29°, in the clockwise sense for cutting right-hand external thread in the case of American National Screw Thread Form, and
in the range from some small angle to 14.5°, but preferably 14.5°, in the clockwise sense for cutting right-hand external threads in the case of the Acme thread form, and
similarly determined feeding angles for other thread forms.

16. The threading tool holder of claim 11 that includes a horizontal cylindrical channel running from one side of said tool holder to the other that can accommodate a boring bar, where the axis of said cylindrical channel bears a precise, predetermined horizontal angle, not zero, to said axis of said rectangular tongue, and that also includes a plurality of vertical retaining nut and bolt receptacles that intersect said cylindrical channel and a plurality of retaining nuts and bolts.

17. The quick-change threading tool holder of claim 16 wherein said certain precise, predetermined horizontal angle is
in the range from some small angle to 30°, but preferably 29°, in the clockwise sense for cutting right-hand external thread in the case of American National Screw Thread Form, and
in the range from some small angle to 14.5°, but preferably 14.5°, in the clockwise sense for cutting right-hand external threads in the case of the Acme thread form, and
similarly determined feeding angles for other thread forms.
